(19) United States
(12) Patent Application Publication
(10) Pub. No.: US 2026/0178201 A1
(43) Pub. Date: Jun. 25, 2026

(54) NONVOLATILE MEMORY DEVICE AND STORAGE SYSTEM COMPRISING THE SAME

(71) Applicant: Samsung Electronics Co., Ltd., Suwon-si (KR)

(72) Inventors: SEUNGHWAN SONG, Suwon-si (KR); WANDONG KIM, Suwon-si (KR); KIWHAN SONG, Suwon-si (KR); SEWON YUN, Suwon-si (KR); YOUNGHA CHOI, Suwon-si (KR); HYUNEE LEE, Suwon-si (KR); YOUNGSEOK JEONG, Suwon-si (KR)

(21) Appl. No.: 19/387,903

(22) Filed: Nov. 13, 2025

(30) Foreign Application Priority Data
Dec. 23, 2024 (KR) 10-2024-0193695

(51) Int. Cl. G06F 3/06

(52) U.S. Cl. CPC G06F 3/0613; G06F 3/0659; G06F 3/0679

(57) ABSTRACT

A nonvolatile memory device includes a memory cell array including a plurality of planes, and a control logic circuit configured to control a data output operation or a data input operation for the plurality of planes in response to a command set, wherein the command set includes addresses for at least two target planes among the plurality of planes.

### CROSS-REFERENCE TO RELATED APPLICATIONS

This application claims priority under 35 U.S.C. § 119 to Korean Patent Application No. 10-2024-0193695 filed on Dec. 23, 2024 in the Korean Intellectual Property Office, the disclosures of which are incorporated by reference herein in their entireties.

### BACKGROUND

Embodiments of the present disclosure described herein relates to a nonvolatile memory device and a storage system including the same.

Semiconductor memory device may be broadly divided into volatile memory device and nonvolatile memory device. Volatile memory device have fast read/write speeds, but have the disadvantage of losing stored contents when the power supply is cut off. On the other hand, nonvolatile memory device keep content even when the power supply is cut off. Therefore, nonvolatile memory device is used to store content that must be retained regardless of whether power is supplied or not.

A representative example of a nonvolatile memory device is a flash memory device. Flash memory device is widely used as a storage medium for voice and image data in information devices such as computers, mobile phones, smart phones, PDAs, digital cameras, camcorders, voice recorders, MP3 players, personal digital assistants PDAs, handheld computers Handheld PCs, game consoles, fax machines, scanners, and printers. Recently, as the information devices using nonvolatile memory device as storage device have become more widespread, improvement in data input/output performance is required.

### SUMMARY

Embodiments of the present disclosure provides a storage system capable of improving data input/output performance by reducing command-address overhead.

According to an embodiment of the inventive concept, a nonvolatile memory device includes a memory cell array including a plurality of planes, and a control logic circuit configured to control a data output operation or a data input operation for the plurality of planes in response to a command set, wherein the command set includes addresses for at least two target planes among the plurality of planes.

According to an embodiment of the inventive concept, a memory controller includes a nonvolatile memory interface configured to communicate with a nonvolatile memory device, and a command manager configured to generate a command set to be transmitted to the nonvolatile memory device through the nonvolatile memory interface, wherein the command set includes addresses for at least two target planes among a plurality of planes included in the nonvolatile memory device.

According to an embodiment of the inventive concept, a storage system includes a first device configured to store data, and a second device configured to receive data from the first device or provide data to the first device, wherein the first device comprises a plurality of planes having memory cells storing data, wherein the second device is configured to generate a command set requesting data input or output for the plurality of planes, wherein the command set includes addresses of at least two target planes among the plurality of planes.

### BRIEF DESCRIPTION OF THE FIGURES

The above and other objects and features of the present disclosure will become apparent by describing in detail embodiments thereof with reference to the accompanying drawings.

FIG. 1 is a block diagram showing a storage system according to an embodiment of the present disclosure.

FIG. 2A to FIG. 2C are diagrams showing a command set according to an embodiment of the present disclosure.

FIG. 3 is a block diagram showing a storage system according to an embodiment of the present disclosure.

FIG. 4 is a block diagram showing a memory controller according to an embodiment of the present disclosure in more detail.

FIG. 5 is a block diagram showing a nonvolatile memory device according to an embodiment of the present disclosure in more detail.

FIG. 6 is a circuit diagram showing one memory block among a plurality of memory blocks according to an embodiment of the present disclosure as an example.

FIG. 7 is a block diagram briefly showing a page buffer according to an embodiment of the present disclosure.

FIG. 8 to FIG. 10B are diagrams for explaining an example of a data input/output operation of a nonvolatile memory device according to an embodiment of the present disclosure.

FIG. 11 is a block diagram showing a storage system according to an embodiment of the present disclosure.

FIG. 12 is a block diagram showing an example of a nonvolatile memory device of FIG. 11 in more detail.

FIG. 13 to FIG. 14C are diagrams for explaining an example of a data output operation of a nonvolatile memory device according to an embodiment of the present disclosure.

FIG. 15 is a block diagram showing a storage system according to an embodiment of the present disclosure.

FIG. 16 is a block diagram showing an example of a nonvolatile memory device of FIG. 15 in more detail.

FIG. 17A and FIG. 17B are diagrams for explaining an example of a data output operation of a nonvolatile memory device according to an embodiment of the present disclosure.

FIG. 18 is a block diagram showing a storage system according to an embodiment of the present disclosure.

FIG. 19 is a block diagram showing an example of a nonvolatile memory device of FIG. 18 in more detail.

FIG. 20 and FIG. 21 are drawings for explaining an example of a data output operation of a nonvolatile memory device according to an embodiment of the present disclosure.

### DETAILED DESCRIPTION

Hereinafter, embodiments of the present invention will be described clearly and in detail so that a person having ordinary skill in the art may easily practice the present invention.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim).

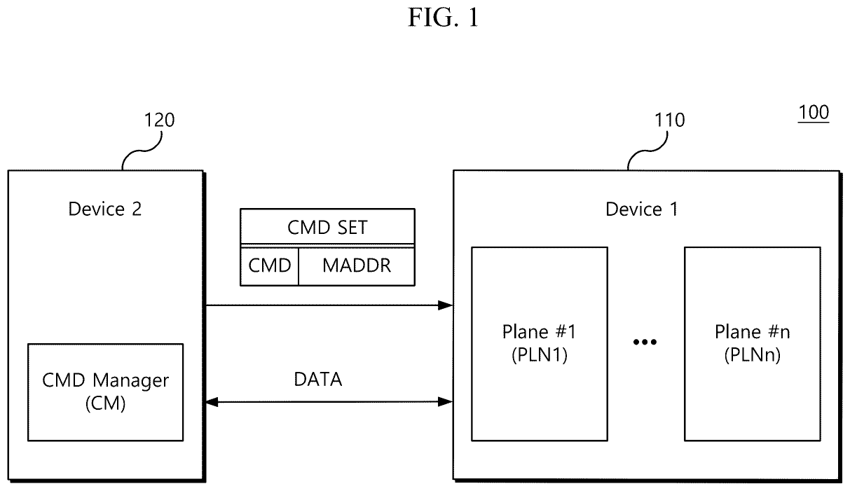

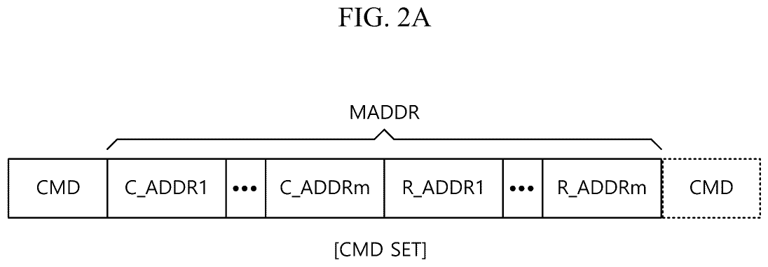

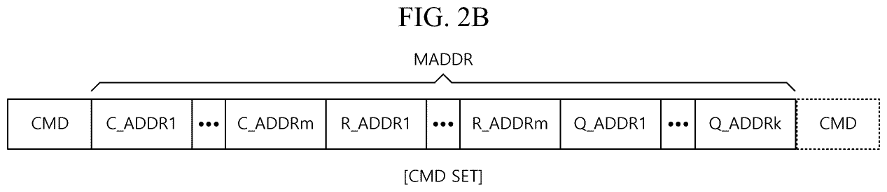

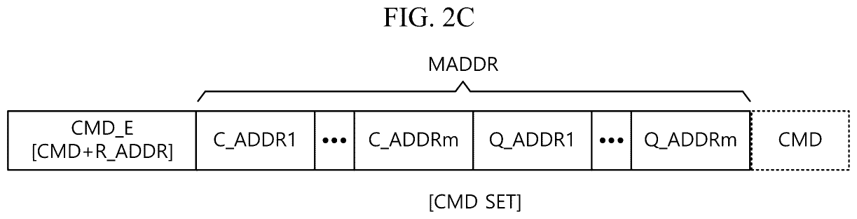

FIG. 1 is a block diagram showing a storage system according to an embodiment of the present disclosure. FIG. 2A to FIG. 2C are drawings showing a command set according to an embodiment of the present disclosure.

The storage system 100 according to an embodiment of the present disclosure includes a first device 110 and a second device 120. The first device 110 may perform a data input/output operation based on a command set CMD SET received from the second device 120. In this case, the command set CMD SET may include addresses for at least two target planes among a plurality of planes. Accordingly, the command-address overhead may be reduced, and the data input/output performance may be improved.

Referring to FIG. 1 to FIG. 2C in more detail, the storage system 100 may include the first device 110 and the second device 120.

The first device 110 may include a plurality of planes PLN1 to PLNn which store data, and each of the plurality of planes PLN1 to PLNn may include memory cells. For example, each of the plurality of planes PLN1 to PLNn may be or include a nonvolatile memory cells such as NAND flash memory cells. As another example, each of the plurality of planes PLN1 to PLNn may be or include volatile memory cells such as a DRAM cells. However, these examples are illustrative, and the present invention is not limited thereto.

The first device 110 may perform a data input/output operation in response to a data input/output request from the second device 120. For example, the first device 110 may receive from the second device 120 a command set CMD SET for data output, and in response thereto, may read data DATA from at least one of the plurality of planes PLN1 to PLNn. Also, for example, the first device 110 may receive from the second device 120 a command set CMD SET for data input, and in response thereto, may store data DATA in at least one of the plurality of planes PLN1 to PLNn.

The second device 120 may be electrically connected to the first device 110. The second device 120 may be, for example, a memory controller that controls the first device 110. However, this is exemplary, and the second device 120 may be a processing unit such as a graphic processing unit GPU, network processing unit NPU, etc. that communicates with the first device 110. The second device 120 may request data input/output to/from the first device 110. For example, the second device 120 may transmit a command set CMD SET to the first device 110 requesting data output. In this case, in response to the corresponding command set CMD SET, the first device 110 may perform a data output operation. Accordingly, data DATA may be transmitted from the first device 110 to the second device 120.

In addition, for example, the second device 120 may transmit a command set CMD SET to the first device 110 requesting data input and data DATA. In this case, in response to the corresponding command set CMD SET, the first device 110 may perform a data input operation.

The second device 120 may include a command manager CM. The command manager CM may generate a command set CMD SET for data input/output.

The command set CMD SET may be a packet that includes at least one command CMD and a multi-plane address MADDR.

The command CMD may be, for example, either a command requesting data output or a command requesting data input. However, this is exemplary and the present disclosure is not limited thereto. According to an embodiment, the command CMD may be any one of various commands defined in the JEDEC standard.

The multi-plane address MADDR may include address information associated with the command CMD. In particular, a multi-plane address MADDR according to an embodiment of the present disclosure may include addresses of at least two target planes corresponding to the command CMD among the plurality of planes PLN1 to PLNn.

As illustrated in FIG. 2A, a command set CMD SET may include at least one command CMD and a multi-plane address MADDR corresponding thereto. In this case, the multi-plane address MADDR may include row addresses R_ADDR1 to RADDRm of at least two target planes and column addresses C_ADDR1_˜C_ADDRm) of the at least two target planes.

For example, assume that data output or data input is requested for two target planes among the plurality of planes PLN1 to PLNn. In this case, the multi-plane address MADDR may include a row address R_ADDR1 for the first target plane, a row address R_ADDR2 for the second target plane, a column address C_ADDR1 for the first target plane, and a column address C_ADDR2 for the second target plane. However, the above described example is exemplary, and the number of target planes may be set in various ways depending on the embodiment.

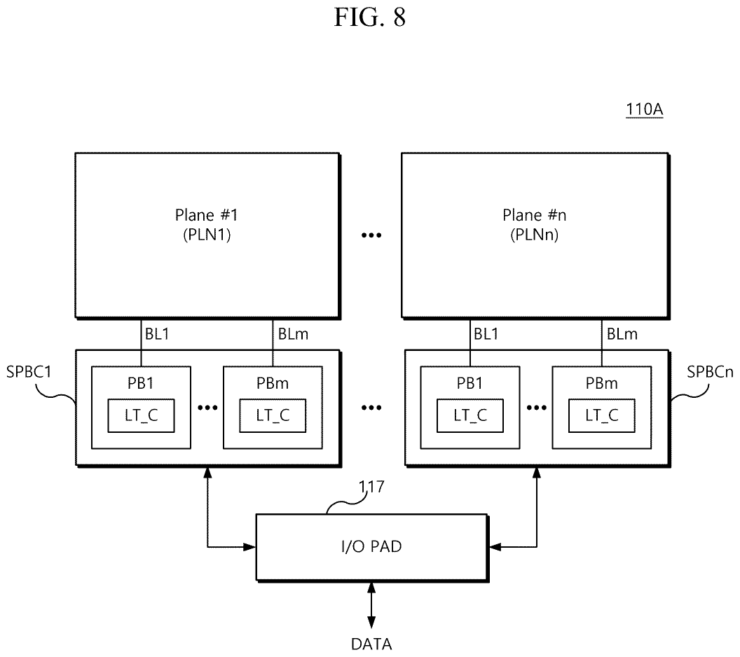

The data input and/or data output operations performed in response to the command set CMD SET such as FIG. 2A will be described in more detail in FIG. 8 to FIG. 10B below.

In addition, as exemplarily illustrated in FIG. 2B, the command set CMD SET includes at least one command CMD and the multi-plane address MADDR corresponding thereto, and the multi-plane address MADDR may further include row addresses R_ADDR1 to RADDRm for at least two target planes, column addresses C_ADDR1 to C_ADDRm for the at least two target planes, and input/output pad addresses Q_ADDR1 to Q_ADDRm corresponding to each of the at least two target planes.

For example, assume that data output for two target planes among the plurality of planes PLN1 to PLNn is requested. In addition, assume that the first device 110 includes a plurality of input/output pads. In this case, the multi-plane address MADDR may include a row address R_ADDR1 for the first target plane, a row address R_ADDR2 for the second target plane, a column address C_ADDR1 for the first target plane, a column address C_ADDR2 for the second target plane, an input/output pad address Q_ADDR1 corresponding to the first target plane, and an input/output pad address Q_ADDR2 corresponding to the second target plane. However, the above described example is exemplary, and the number of target planes may be set in various ways depending on the embodiment.

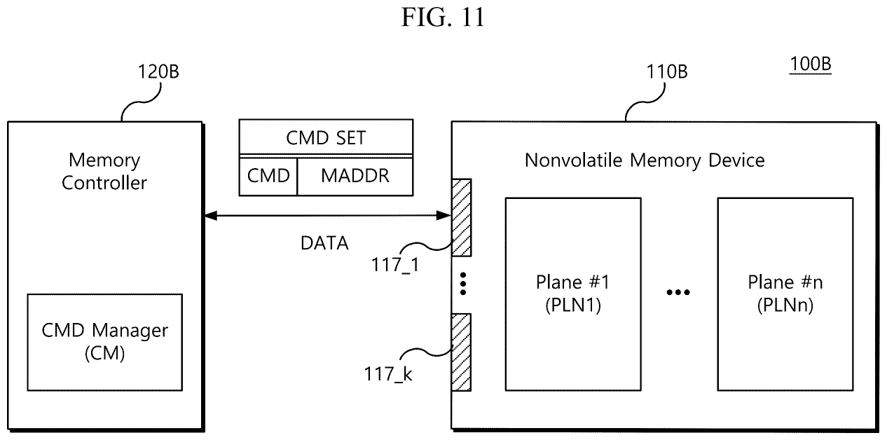

The data input and/or data output operations performed in response to a command set CMD SET such as FIG. 2B will be described in more detail in FIG. 11 to FIG. 17B below.

In addition, as exemplarily illustrated in FIG. 2C, the command set CMD SET may include at least one encoded command CMD_E and a multi-plane address MADDR. The encoded command CMD_E may include a command CMD and row addresses R_ADDR for at least two target planes corresponding to the command CMD. The multi-plane address MADDR may further include column addresses C_ADDR1 to C_ADDRm for the at least two target planes, and input/output pad addresses Q_ADDR1 to Q_ADDRm corresponding to each of the at least two target planes.

For example, assume that data input or data output is requested for two target planes among the plurality of planes PLN1 to PLNn. In addition, assume that the first device 110 includes a plurality of input/output pads.

In this case, the row address of the first target plane and the row address of the second target plane are encoded together with the command CMD, and thus the encoded command CMD_E may be generated. The encoded command CMD_E may include not only the command CMD for data input/output, but also the row address for the first target plane and the row address for the second target plane. In addition, the multi-plane address MADDR may include the column address C_ADDR1 for the first target plane, the column address C_ADDR2 for the second target plane, the input/output pad address Q_ADDR1 for the first target plane, and the input/output pad address Q_ADDR2 for the second target plane.

However, this is an example, and the present invention is not limited thereto. The number of target planes may be set in various ways depending on the embodiment. In addition, according to an embodiment, the encoded command CMD_E may be encoded to include the column address for the target plane, or may be encoded to include the row address and the column address for the target plane. In addition, according to an embodiment, the multi-plane address MADDR may not include the input/output pad addresses Q_ADDR1 to Q_ADDRm.

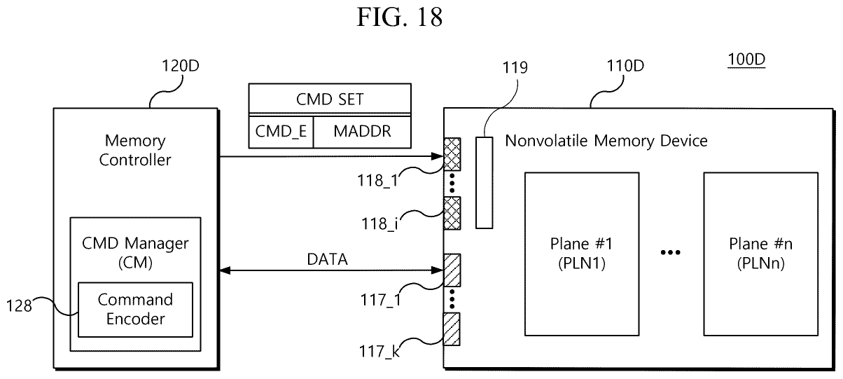

The data input and/or data output operations performed in response to the command set CMD SET as in FIG. 2C will be described in more detail in FIG. 18 to FIG. 21 below.

As discussed in FIG. 1 to FIG. 2C, the command set CMD SET according to embodiments of the present disclosure includes the multi-plane address MADDR, and the multi-plane address MADDR may include addresses for at least two target planes among the plurality of planes. Accordingly, the command-address overhead may be reduced during data input/output operations, and the data input/output performance may be improved.

Hereinafter, various configurations and operations of a storage system according to embodiments of the present disclosure will be described in more detail.

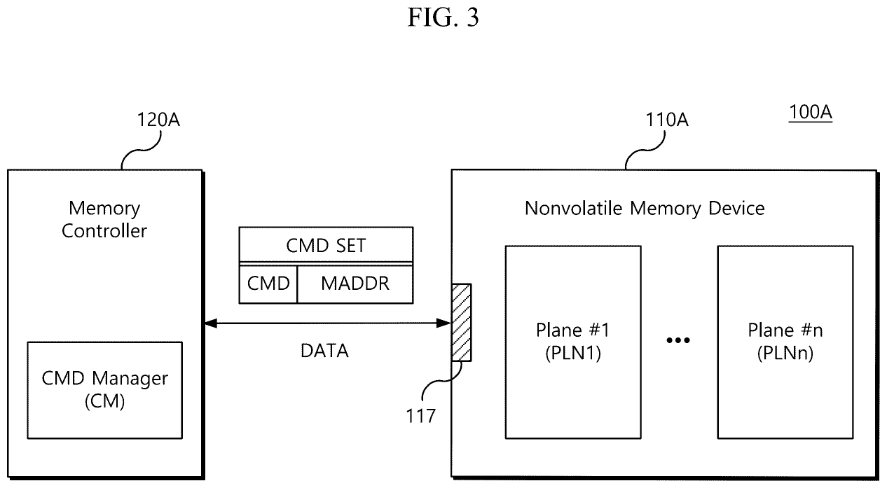

FIG. 3 is a block diagram showing a storage system according to an embodiment of the present disclosure. In FIG. 3, for example, a storage system 100A implemented with a nonvolatile memory device and a memory controller controlling the same is illustrated. The storage system 100A of FIG. 3 is similar to the storage system 100 of FIG. 1. Therefore, the same or similar components in FIG. 3 are indicated by the same or similar reference numerals, and duplicated descriptions will be omitted. Referring to FIG. 3, the storage system 100A may include a nonvolatile memory device 110A and a memory controller 120A.

The nonvolatile memory device 110A may include a plurality of planes PLN1 to PLNn. Each of the plurality of planes PLN1 to PLNn may be or include a plurality of memory cells. For example, each of the plurality of planes PLN1 to PLNn may include a plurality of NAND flash memory cells. However, the above description is an example, and the present invention is not limited thereto.

The nonvolatile memory device 110A may further include an input/output pad 117. The nonvolatile memory device 110A may receive or transmit a command set CMD SET and/or data DATA through the input/output pad 117. For example, the nonvolatile memory device 110A may receive the command set CMD SET for a data output operation from the memory controller 120A through the input/output pad 117. In this case, the nonvolatile memory device 110A may transmit data DATA of the target plane to the memory controller 120A through the input/output pad 117.

For example, the nonvolatile memory device 110A may receive the command set CMD SET and data DATA for a data input operation from the memory controller 120A through the input/output pad 117. In this case, the nonvolatile memory device 110A may store the data DATA in the target plane.

The memory controller 120A may be electrically connected to the nonvolatile memory device 110A. The memory controller 120A may request the nonvolatile memory device 110A to store the data DATA or request the nonvolatile memory device 110A to read the data DATA stored in the nonvolatile memory device 110A. For this purpose, the memory controller 120A may include a command manager CM.

The command manager CM may generate various commands CMDs and corresponding addresses for data DATA exchange between the memory controller 120A and the nonvolatile memory device 110A. The commands CMDs and corresponding addresses may be referred to as the command set CMD SET.

In one embodiment of the present disclosure, the command set CMD SET may include at least one command CMD and a multi-plane address MADDR. The multi-plane address MADDR may include addresses for at least two target planes corresponding to the command CMD among the plurality of planes PLN1 to PLNn.

For example, if the command CMD corresponds to a data output command, the multi-plane address MADDR may include addresses for at least two target planes corresponding to the data output command among the plurality of planes PLN1 to PLNn. In this case, one data output command and addresses for at least two target planes corresponding thereto may be transmitted to the nonvolatile memory device 110A through the input/output pad 117.

Alternatively, for example, if the command CMD corresponds to a data input command, the multi-plane address MADDR may include addresses for at least two target planes corresponding to the data input command among the plurality of planes PLN1 to PLNn. In this case, one data output command and addresses for at least two target planes corresponding thereto, and data DATA to be stored in the at least two target planes may be transmitted to the nonvolatile memory device 110A through the input/output pad 117.

Typically, one data input/output command corresponds to an address of single target plane. Therefore, conventionally, for data input/output operations for multiple target planes, multiple data input/output commands are also required.

In contrast, the command set CMD SET according to embodiments of the present disclosure includes one command CMD and a multi-plane address MADDR. The multi-plane address MADDR may include addresses for at least two target planes corresponding to one command CMD. Accordingly, compared to a case where an address for one target plane is required for one command, the data input/output operation according to embodiments of the present disclosure may reduce the command-address overhead. As a result, the data input/output performance may be improved.

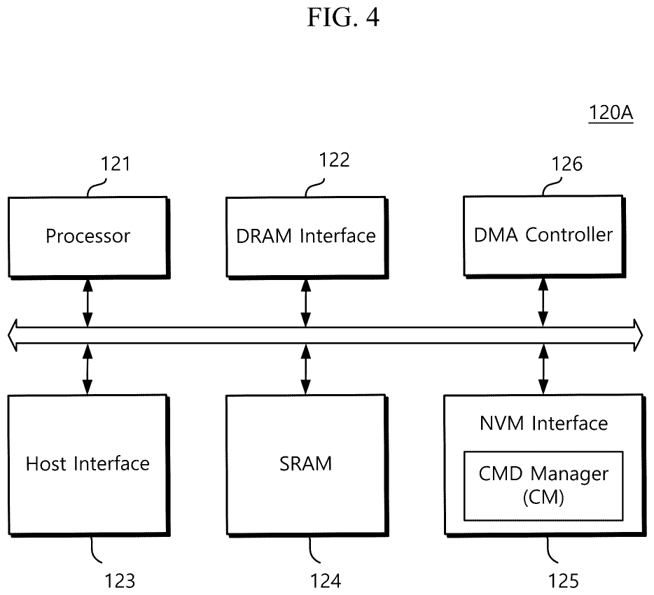

FIG. 4 is a block diagram showing a memory controller according to an embodiment of the present disclosure in more detail. The memory controller of FIG. 4 may correspond to the memory controller of FIG. 3. Referring to FIG. 4, the memory controller 120A may include a processor 121, a DRAM interface 122, a host interface 123, an SRAM 124, a nonvolatile memory interface 125, and a direct memory access (DMA) controller 126.

The processor 121 may control the overall operation of the memory controller 120A. For example, the processor 121 may execute various applications running on the memory controller 120A.

The DRAM interface 122 may provide interfacing with an external DRAM device. For example, the memory controller 120A may temporarily store data in the DRAM device or read data stored in the DRAM device through the DRAM interface 122.

The host interface 123 may provide interfacing with an external host. For example, the memory controller 120A may communicate with the host through the host interface 123. For example, the host interface 123 may include at least one of various host interfaces such as a PCI-express (Peripheral Component Interconnect express) interface, an NVMe (nonvolatile memory express) interface, a SATA (Serial ATA) interface, a SAS (Serial Attached SCSI) interface, a UFS (Universal Flash Storage) interface, etc.

The SRAM 124 may be used as a buffer memory, an operating memory, or a cache memory of the memory controller 120A. For example, the SRAM 124 may store various data such as programs, applications, and firmware executed by the processor 121.

The nonvolatile memory interface 125 may provide interfacing with the nonvolatile memory device 110A. For example, the memory controller 120A may communicate with the nonvolatile memory device 110A through the nonvolatile memory interface 125.

The nonvolatile memory interface 125 may include a command manager CM. The command manager CM may generate various command sets for controlling the nonvolatile memory device 110A. For example, the command manager CM may generate various commands such as a program command, a read command, a memory access command, a data output command, a data input command, etc.

In one embodiment of the present disclosure, the command manager CM may generate a command set CMD SET including a command CMD and a multi-plane address MADDR. In this case, the multi-plane address MADDR may include addresses for at least two target planes corresponding to the command CMD. Accordingly, command-address overhead may be reduced during a data input/output operation, and thus data input/output performance may be improved.

According to an embodiment, the memory controller 120A may further include a DMA controller 126. The DMA controller 126 may perform a DMA operation that controls data transfer between the DRAM device and the nonvolatile memory device 110A.

For example, the DMA operation may be performed on a plane-by-plane basis. In this case, data stored in the nonvolatile memory device 110A may be transferred to the DRAM device in plane units, or data stored in the DRAM device may be transferred to the nonvolatile memory device 110A in plane units. However, this description is an example, and the present invention is not limited thereto. The DMA operation may be performed in units smaller than the plane, such as blocks depending on the embodiment.

In one embodiment of the present disclosure, the DMA operation may be performed by a command set CMD SET including a multi-plane address MADDR. Accordingly, the command-address overhead may be reduced during the DMA operation, and thus the data input/output performance may be improved.

In FIG. 4, the DRAM device is described as being located outside the memory controller 120A. However, this description is an example, and the present invention is not limited thereto. Depending on the embodiment, the memory controller 120A may be implemented to include the DRAM device. In addition, in FIG. 4, the DMA controller 126 is described as being located inside the memory controller 120A. However, this description is exemplary, and the present invention is not limited thereto. Depending on the embodiment, the DMA controller 126 may be implemented to be located outside the memory controller 120A.

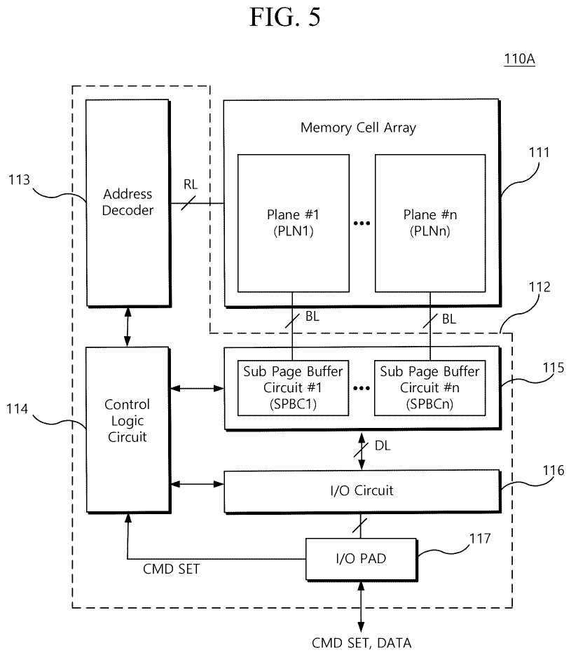

FIG. 5 is a block diagram showing a nonvolatile memory device 110A according to an embodiment of the present disclosure in more detail. The nonvolatile memory device of FIG. 5 may correspond to the nonvolatile memory device of FIG. 3. Referring to FIG. 5, the nonvolatile memory device 110A includes a memory cell array 111 and a peripheral circuit 112. The peripheral circuit 112 may include an address decoder 113, a control logic circuit 114, a page buffer circuit 115, an input/output circuit 116, and an input/output pad 117.

The memory cell array 111 includes a plurality of planes PLN1 to PLNn, and each of the plurality of planes PLN1 to PLNn may include memory blocks. Each memory block may have a two-dimensional structure or a three-dimensional structure. In a memory block having a two-dimensional structure (or horizontal structure), memory cells may be formed in a horizontal direction with respect to the substrate. In a memory block having a three-dimensional structure (or vertical structure), memory cells may be formed in the horizontal direction and in a vertical direction with respect to the substrate. Each plane may include a set of memory blocks, for example, a set of two or more memory blocks, and/or may include its own data and cache register.

The plurality of memory blocks may include at least one of a single-level cell block including single-level cells SLCs, or a multi-level cell block including multi-level cells MLCs, such as double-level cell block DLCs, a triple-level cell block including triple-level cells TLCs, or a quad-level cell block including quad-level cells QLCs. Some of the memory blocks included in the memory cell array 111 may be single-level cell blocks, and other memory blocks may be multi-level cell blocks.

The address decoder 113 may be connected to the memory cell array 111 through row lines RL. The row lines RL may include string selection lines, ground selection lines, word lines, dummy word lines, and gate induced drain leakage (GIDL) lines.

The page buffer circuit 115 may be connected to the memory cell array 111 via bit lines BL. The page buffer circuit 115 may temporarily store data to be programmed in a selected page or data read from a selected page. The page buffer circuit 115 may include a plurality of sub-page buffer circuits SPBC1 to SPBCn.

Each of the plurality of sub-page buffer circuits SPBC1 to SPBCn may be connected to a respective plane of plurality of planes PLN1 to PLNn via bit lines BL. For example, the first sub-page buffer circuit SPBC1 may be connected to the first plane PLN1 via bit lines BL, and the nth sub-page buffer circuit SPBCn may be connected to the nth plane PLNn via bit lines BL.

Each sub-page buffer circuit may include a plurality of page buffers, each of which is connected to a bit line of a plurality of bit lines BL. For example, one page buffer may be arranged corresponding to one bit line, and each page buffer may include at least one latch.

The input/output circuit 116 may be connected to the page buffer circuit 115 through data lines DL. The input/output circuit 116 may receive data DATA through the input/output pad 117 and transmit the received data DATA to the page buffer circuit 115. In addition, the input/output circuit 116 may receive data DATA from the page buffer circuit 115 and transmit the received data DATA to the memory controller 120A through the input/output pad 117.

The input/output pad 117 may receive a command set CMD SET and data DATA from the memory controller 120A. The input/output pad 117 may transmit the received command set CMD SET to the control logic circuit 114 and transmit the received data DATA to the input/output circuit 116. In addition, the input/output pad 117 may receive data DATA from the input/output circuit 116 and transmit the received data DATA to the memory controller 120A.

The control logic circuit 114 may receive the command set CMD SET through the input/output pad 117. The control logic circuit 114 may control the overall operation of the nonvolatile memory device 110A based on the received command set CMD SET.

In one embodiment of the present disclosure, the command set CMD SET may include a command CMD requesting data output and a multi-plane address MADDR corresponding thereto. The multi-plane address MADDR may include addresses for at least two target planes. For example, assume that data output is requested for two target planes among multiple planes PLN1 to PLNn. In this case, the multi-plane address MADDR may include a first row address R_ADDR1 for the first target plane, a second row address R_ADDR2 for the second target plane, a first column address C_ADDR1 for the first target plane, and a second column address C_ADDR2 for the second target plane.

In this case, at least two target planes among the plurality of planes PLN1 to PLNn may be selected. For example, among the multi-plane address MADDR, the first row address R_ADDR1 for the first target plane and the second row address R_ADDR2 for the second target plane may be decoded by the address decoder 113, and accordingly, a row line RL corresponding to the first target plane and a row line RL corresponding to the second target plane may be selected. Among the multi-plane address MADDR, the first column address C_ADDR1 for the first target plane and the second column address C_ADDR2 for the second target plane may be decoded by the control logic circuit 114, and accordingly, a bit line BL corresponding to the first target plane and a bit line BL corresponding to the second target plane may be selected.

Data DATA stored in each of the selected at least two target planes may be stored in a corresponding sub-page buffer circuit via corresponding bit lines BL. Thereafter, the data stored in each sub-page buffer circuit may be transmitted to the memory controller 120A via the input/output circuit 116 and the input/output pad 117.

In one embodiment of the present disclosure, the command set CMD SET may include a command CMD requesting data input and a multi-plane address MADDR corresponding thereto. The multi-plane address MADDR may include addresses for at least two target planes. For example, assume that data input is requested for two target planes among multiple planes PLN1 to PLNn. In this case, the multi-plane address MADDR may include a first row address R_ADDR1 for the first target plane, a second row address R_ADDR2 for the second target plane, a first column address C_ADDR1 for the first target plane, and a second column address C_ADDR2 for the second target plane.

In this case, data DATA received from the memory controller 120A may be stored in at least two sub-page buffer circuits selected through the input/output pad 117 and the input/output circuit 116. The at least two selected sub-page buffer circuits may correspond to at least two target planes, respectively. For example, among the multi-plane address MADDR, the first column address C_ADDR1 for the first target plane and the second column address C_ADDR2 for the second target plane may be decoded by the control logic circuit 114, and accordingly, a first sub-page circuit connected to a bit line BL corresponding to the first target plane and a second sub-page circuit connected to a bit line BL corresponding to the second target plane may be selected.

Thereafter, data stored in each sub-page buffer circuit may be stored in the corresponding target plane through the bit lines BL. For example, among the multi-plane address MADDR, a first row address R_ADDR1 for the first target plane and a second row address R_ADDR2 for the second target plane are decoded by the address decoder 113, and accordingly, a row line RL corresponding to the first target plane and a row line RL corresponding to the second target plane can be selected. Accordingly, data stored in each sub-page buffer circuit can be stored in the corresponding target plane through the bit lines BLs.

As described above, the nonvolatile memory device 110A according to embodiments of the present disclosure may perform the data input/output operation in response to the command set CMD SET including addresses for at least two target planes. Accordingly, the command-address overhead may be reduced during the data input/output operation, and thus the data input/output performance may be improved.

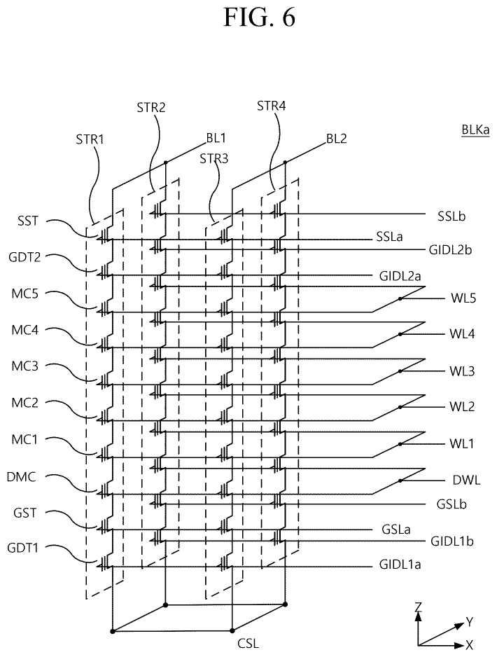

FIG. 6 is a circuit diagram exemplarily showing one memory block among a plurality of memory blocks according to an embodiment of the present disclosure. The memory block of FIG. 6 may be one of the memory blocks included in the plane of FIG. 5. For convenience of explanation, it is assumed that one memory block includes four strings STR1 to STR4. Referring to FIG. 6, the memory block BLKa may include a plurality of strings STR1 to STR4, each string including cell transistors vertically stacked on a substrate. The plurality of strings STR1 to STR4 may be arranged in a first direction (i.e., X-axis direction) and a second direction (i.e., Y-axis direction).

Among the plurality of strings STR1 to STR4, strings located in the same column may be connected to the same bit line. For example, the first and second strings STR1 and STR2 may be connected to the first bit line BL1, and the third and fourth strings STR3 and STR4 may be connected to the second bit line BL2.

Each of the plurality of strings STR1 to STR4 may include a plurality of cell transistors. Each of the plurality of cell transistors may be a charge trap flash CTF memory cell, but the scope of the present invention is not limited thereto. The plurality of cell transistors may be stacked along the third direction (i.e., Z-axis direction).

The plurality of strings STR1 to STR4 may be commonly connected to a common source line CSL. For example, as illustrated in FIG. 6, the common source line CSL may be commonly connected to the bottoms of the plurality of strings STR1 to STR4. However, this description is an example, and the common source line CSL is sufficiently electrically connected to the bottom of the strings STR1 to STR4, and is not limited to being physically located at the bottom of the strings STR1 to STR4. Hereinafter, for convenience of explanation, the structure and configuration of the string will be described based on the first string STR1. The other strings STR2, STR3 and STR3 may have a structure similar to the first string STR1, and a detailed description thereof will be omitted.

A plurality of cell transistors may be connected in series between the first bit line BL1 and the common source line CSL. For example, the plurality of cell transistors may include GIDL transistors GDT1 and GDT2, a string select transistor SST, memory cells MC1 to MC5, a dummy memory cell DMC, and ground select transistor GST.

The first GIDL transistor GDT1 may be arranged at the bottom of the first string STR1. For example, the first GIDL transistor GDT1 may be connected to the common source line CSL at the bottom of the first string STR1. However, this description is exemplary, and the present invention is not limited thereto. The gate of the first GIDL transistor GDT1 may be connected to the first GIDL line GIDL1a.

The second GIDL transistor GDT2 may be arranged at the top of the first string STR1, but may be arranged between the string select transistor SST and the memory cell MC5. In other words, the second GIDL transistor GDT2 may be connected to the first bit line BL1 through the string select transistor SST. The gate of the second GIDL transistor GDT2 may be connected to the second GIDL line GIDL2a.

In FIG. 6, it is illustrated that GIDL transistors GDT1 and GDT2 are provided at the top and bottom of the first string STR1. However, this description is an example, and depending on the embodiment, the GIDL transistor may be provided only at the top of the first string STR1, or the GIDL transistor may be provided only at the bottom of the first string STR1.

One string select transistor SST may be placed at the top of the string STR. The string select transistor SST may be connected to the first bit line BL1 at the top of the first string STR1. The gate of the string select transistor SST may be connected to the string select line SSLa. However, this description is an example, and depending on the embodiment, a plurality of string select transistors connected in series may be provided between the first bit line BL1 and the second GIDL transistor GDT2.

One ground selection transistor GST may be provided between the dummy memory cell DMC and the first GIDL transistor GDT1. The gate of the ground selection transistor GST may be connected to the ground selection line GSLa. However, this description is exemplary, and according to an embodiment, a plurality of ground selection transistors connected in series may be provided between the dummy memory cell DMC and the first GIDL transistor GDT1.

The first to fifth memory cells MC1 to MC5 may be connected in series between the string selection transistor SST and the dummy memory cell DMC. The gates of the first to fifth memory cells MC1 to MC5 may be connected to the first to fifth word lines WL1 to WL5, respectively.

The dummy memory cell DMC may be provided between the first memory cell MC1 and the first GIDL transistor GDT1. The gate of the dummy memory cell DMC may be connected to a dummy word line DWL. However, this description is exemplary, and according to an embodiment, a plurality of dummy memory cells connected in series may be provided between the first memory cell MC1 and the first GIDL transistor GDT1. Alternatively, an additional dummy memory cell may be provided between the string select transistor SST and the fifth memory cell MC5. Alternatively, an additional dummy memory cell may be provided between the memory cells MC1 to MC5. Alternatively, the dummy memory cell DMC may not be provided.

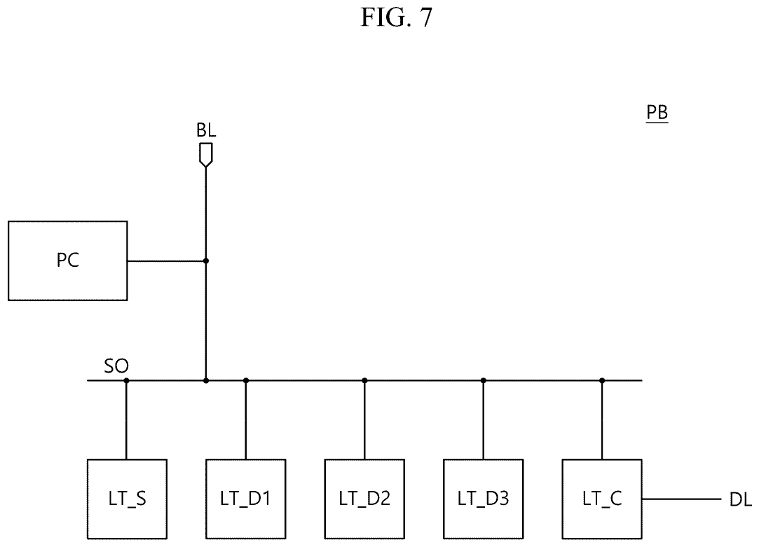

FIG. 7 is a block diagram briefly showing a page buffer according to an embodiment of the present disclosure. The page buffer of FIG. 7 may correspond to any one of the page buffers included in the sub-page buffer circuit of FIG. 5. Referring to FIG. 7, the page buffer PB may be connected to a bit line BL (e.g., a single bit line BL). The page buffer PB may include a sensing node SO connected to the bit line BL. In addition, the page buffer PB may include a precharge circuit PC and a plurality of latches LT_S, LT_D1 to LT_D3 and LT_C each connected to the sensing node SO.

The precharge circuit PC may precharge the bit line BL to either a program allow voltage or a program inhibit voltage under the control of a control logic circuit (114, see FIG. 5).

Among the plurality of latches LT_S, LT_D1 to LT_D3 and LT_C, the sensing latch LT_S may store data sensed through the bit line BL. Alternatively, the sensing latch LT_S may store precharge data to be used for determining the precharge voltage.

Among the plurality of latches LT_S, LT_D1 to LT_D3 and LT_C, the data latches LT_D1 to LT_D3 may temporarily store data to be programmed in the memory cell. For example, when the memory cell stores 3-bit data, each of the data latches LT_D1 to LT_D3 may store data corresponding to the highest page, data corresponding to the middle page, and data corresponding to the lowest page.

Among the plurality of latches LT_S, LT_D1 to LT_D3 and LT_C, the cache latch LT_C may be connected to the input/output circuit (116, see FIG. 5) via the data line DL. The cache latch LT_C may store data received from the input/output circuit 116. Alternatively, the cache latch LT_C may also store data to be transmitted to the input/output circuit 116.

In FIG. 7, the page buffer PB is described as including five latches. However, this example is an exemplary, and the number of latches included in the page buffer PB is not limited thereto.

FIG. 8 to FIG. 10B are drawings for explaining an example of a data input/output operation of a nonvolatile memory device according to an embodiment of the present disclosure.

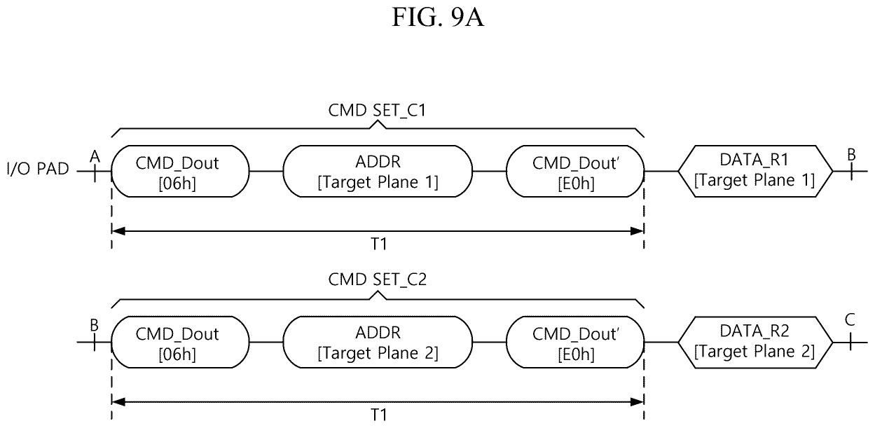

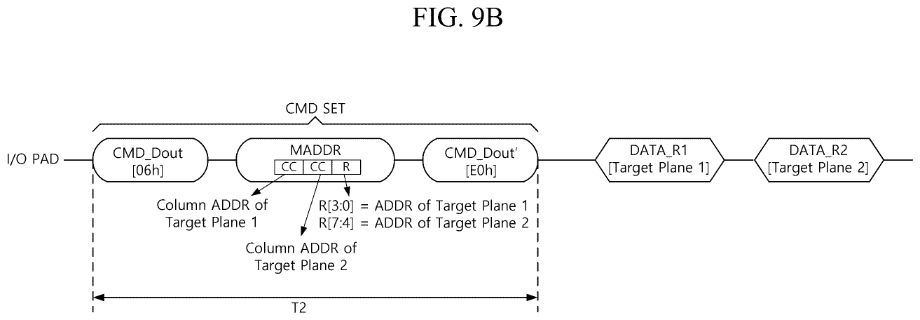

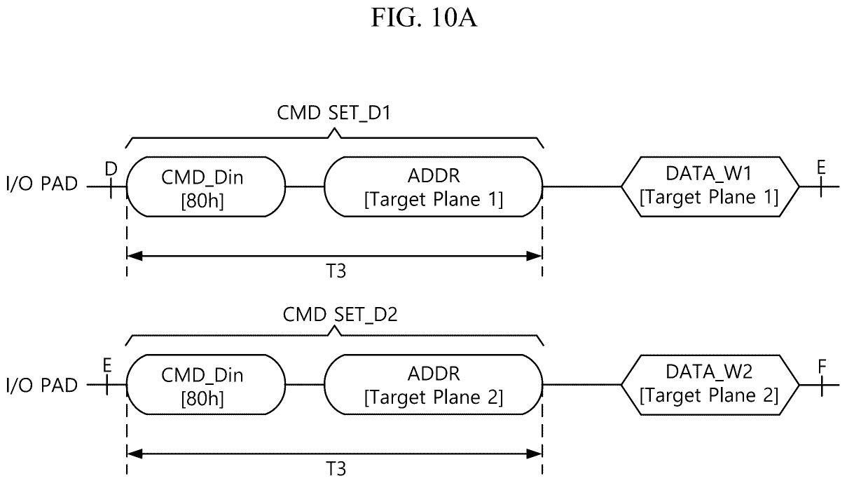

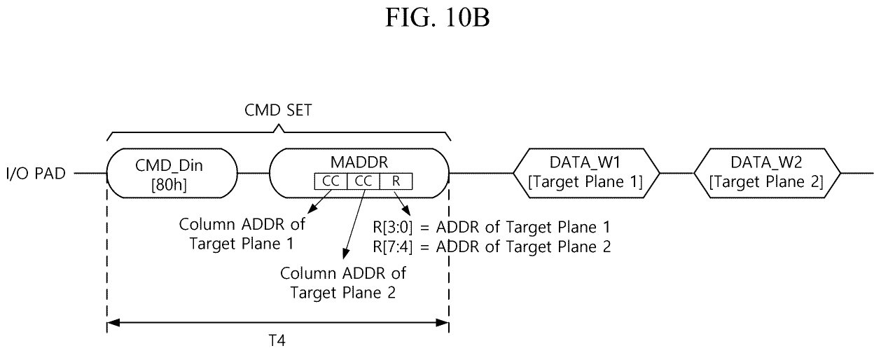

Specifically, FIG. 8 illustrates an example of a correspondence relationship between one input/output pad and a plurality of sub-page buffer circuits. FIG. 9A illustrates a comparative example of a data output sequence in a case where a multi-plane address is not supported. FIG. 9B illustrates a data output sequence according to an embodiment of the present disclosure. FIG. 10A illustrates a comparative example of a data input sequence in a case where the multi-plane address is not supported. FIG. 10B illustrates a data input sequence according to an embodiment of the present disclosure.

For convenience of explanation, the following will mainly describe the data input/output operation in a DMA operation. In this case, the DMA operation is performed in plane units, and therefore, only an address of a target plane will be provided as a row address. Referring to FIG. 8, the nonvolatile memory device 110A may include a plurality of planes PLN1 to PLNn, a plurality of sub-page buffer circuits SPBC1 to SPBCn, and one input/output pad 117.

The first plane PLN1 may be connected to the first sub-page buffer circuit SPBC1 via bit lines BL1 to BLm. The first sub-page buffer circuit SPBC1 includes a plurality of page buffers PB1 to PBm, and each page buffer may be connected to a corresponding bit line. Each of the plurality of page buffers PB1 to PBm may include a cache latch LT_C.

Similarly, the nth plane PLNn may be connected to the nth sub-page buffer circuit SPBCn via bit lines BL1 to BLm. The nth sub-page buffer circuit SPBCn includes a plurality of page buffers PB1 to PBm, and each page buffer may be connected to a corresponding bit line. Each of the plurality of page buffers PB1 to PBm may include a cache latch LT_C.

The input/output pad 117 may correspond to the plurality of sub-page buffer circuits SPBC1 to SPBCn in common.

In one embodiment of the present disclosure, the input/output pad 117 may be selectively connected to any one of the plurality of sub-page buffer circuits SPBC1 to SPBCn during a data input/output operation.

For example, during a data output operation for the first plane PLN1, the input/output pad 117 may be connected to the first sub-page buffer circuit SPBC1. Accordingly, data DATA stored in the cache latches LT_Cs of the first sub-page buffer circuit SPBC1 may be transmitted to the outside through the input/output pad 117. In addition, during a data input operation for the first plane PLN1, the input/output pad 117 may be connected to the first sub-page buffer circuit SPBC1. Accordingly, data DATA received from the outside may be stored in the cache latches LT_Cs of the first sub-page buffer circuit SPBC1 through the input/output pad 117.

Similarly, during a data input/output operation for the nth plane PLNn, the input/output pad 117 may be connected to the nth sub-page buffer circuit SPBCn.

In one embodiment, the nonvolatile memory device 110A may include a switch circuit for selectively connecting the input/output pad 117 to one of the plurality of sub-page buffer circuits SPBC1 to SPBCn. The switch circuit may include at least one switch. The switch may be implemented to include, for example, a switching transistor.

For example, a first switch may be arranged between the first sub-page buffer circuit SPBC1 and the input/output pad 117. When the first sub-page buffer circuit SPBC1 is selected, the first switch may be turned on. Accordingly, the first sub-page buffer circuit SPBC1 may be electrically connected to the input/output pad 117.

For example, an n-th switch may be arranged between the n-th sub-page buffer circuit SPBCn and the input/output pad 117. When the n-th sub-page buffer circuit SPBCn is selected, the n-th switch can be turned on. Accordingly, the n-th sub-page buffer circuit SPBCn can be connected to the input/output pad 117.

In one embodiment, switching between the input/output pad 117 accessing different sub-page buffer circuits SPBCn may be performed by connecting the input/output pad 117 to a plurality of lines between the input/output pad 117 and the different sub-page buffer circuits SPBCn and a plurality of switching transistors connected to the plurality of lines.

Referring to FIG. 8 and FIG. 9A, data output operations for the first target plane and the second target plane may be performed in a situation where a multi-plane address is not supported.

To be specific, firstly, a first command set CMD SET_C1 may be received through an input/output pad. The first command set CMD SET_C1 may include a data output command CMD_Dout, an address ADDR, and a data output command CMD_Dout′. For example, the data output commands CMD_Dout and CMD_Dout′ may be “06 h” and “E0h”. The address ADDR may include a row address for the first target plane. Receiving the first command set CMD SET_C1 may take a first time T1.

In this case, the nonvolatile memory device may output data DATA_R1 stored in the cache latches LT_C of the sub-page buffer circuit corresponding to the first target plane through the input/output pad. The data output operation for the first target plane may be performed between the ‘A’ time point and the ‘B’ time point.

Thereafter, the second command set CMD SET_C2 may be received through the input/output pad. The second command set CMD SET_C2 may include a data output command CMD_Dout, an address ADDR, and a data output command CMD_Dout′. The address ADDR may include a row address for the second target plane. It may take the first time T1 to receive the second command set CMD SET_C2.

In this case, the nonvolatile memory device may output data DATA_R2 stored in the cache latches LT_C of the sub-page buffer circuit corresponding to the second target plane through the input/output pad. This data output operation for the second target plane may be performed between the ‘B’ time point and the ‘C’ time point.

As a result, as illustrated in FIG. 9A, in order to perform the data output operation for the first target plane and the second target plane, it may take ‘2*T1’ time to receive the command and address. If the total time for outputting data for the first target plane and the second target plane (i.e., the time between the ‘A’ time point and the ‘C’ time point) is determined in advance, the time for actually outputting the data may be reduced. Therefore, this command-address overhead needs to be reduced.

Referring to FIG. 8 and FIG. 9B, in a situation where a multi-plane address is supported according to an embodiment of the present disclosure, data output operations for the first target plane and the second target plane may be performed.

Specifically, a command set CMD SET according to an embodiment of the present disclosure may be received through the input/output pad 117. The command set CMD SET may include a data output command CMD_Dout, a multi-plane address MADDR, and a data output command CMD_Dout′. For example, the data output commands CMD_Dout and CMD_Dout′ may be “06h” and “E0h”.

The multi-plane address MADDR may include row addresses for two target planes. For example, the row address ‘R’ has a bit width of 1-byte, and ‘R[3:0]’ may correspond to an address of the first target plane, and ‘R[7:4]’ may correspond to an address of the second target plane.

In addition, the multi-plane address MADDR may include column addresses for two target planes. For example, the column address ‘C’ has a bit width of 1-byte, and among the 4-byte column addresses ‘CCCC’, the first ‘CC’ may correspond to a column address for the first target plane, and the second ‘CC’ may correspond to a column address for the second target plane. Here, the column address may correspond to, for example, a column address of a bit line or a column address of a cache latch. It may take a second time T2 to receive the command set CMD SET, and the second time T2 may be the same as or similar to the first time T1.

In this case, the nonvolatile memory device 110A may sequentially output data DATA_R1 stored in cache latches LT_C of the sub-page buffer circuit corresponding to the first target plane and data DATA_R2 stored in cache latches LT_C of the sub-page buffer circuit corresponding to the second target plane. For example, as described in FIGS. 1 to 5, the nonvolatile memory device 110A can select a first sub-page buffer circuit corresponding to a first target plane and a second sub-page buffer circuit corresponding to a second target plane by decoding column addresses for two target planes. Thereafter, the nonvolatile memory device 110A can sequentially output data DATA_R1 stored in cache latches LT_C of the sub-page buffer circuit corresponding to the first target plane and data DATA_R2 stored in cache latches LT_C of the sub-page buffer circuit corresponding to the second target plane. For example, the nonvolatile memory device 110A may identify the first target plane through the row address ‘R[3:0]’ of the multi-plane address MADDR and the first ‘CC’ in the column address ‘CCCC’ of the multi-plane address MADDR, and output the data DATA_R1 stored in the cache latches LT_C of the sub-page buffer circuit corresponding to the first target plane. Furthermore, the nonvolatile memory device 110A may identify the second target plane through the row address ‘R[7:4]’ of the multi-plane address MADDR and the second ‘CC’ in the column address ‘CCCC’ of the multi-plane address MADDR, and output the data DATA_R2 stored in the cache latches LT_C of the sub-page buffer circuit corresponding to the second target plane.

As a result, compared to FIG. 9A, the time required to receive a command set required for the data output operation according to the embodiment of the present disclosure illustrated in FIG. 9B may be reduced compared to FIG. 9A. In this way, the data output performance may be improved by reducing the command-address overhead.

Similarly, the data input operation according to the embodiment of the present disclosure may also have a reduced command-overhead compared to the general case.

Referring to FIG. 8 and FIG. 10A, in a situation where a multi-plane address is not supported, a data input operation for the first target plane and the second target plane may be performed.

To be specific, first, a first command set CMD SET_D1 may be received through an input/output pad. The first command set CMD SET_D1 may include a data input command CMD_Din and an address ADDR. For example, the data input command CMD_Din may be “80h”. The address ADDR may include a row address for the first target plane. It may take a third time T3 to receive the first command set CMD SET_D1. Thereafter, data DATA_W1 for the first target plane is received through the input/output pad, and the nonvolatile memory device may store the data DATA_W1 in the cache latches LT_C of the sub-page buffer circuit corresponding to the first target plane. This data output operation for the first target plane may be performed between the ‘D’ time point and the ‘E’ time point.

Thereafter, the second command set CMD SET_D2 may be received through the input/output pad. The second command set CMD SET_C2 may include a data input command CMD_Din and an address ADDR. The address ADDR may include a row address for the second target plane. It may take a third time T3 to receive the second command set CMD SET_D2. Thereafter, data DATA_W2 for the second target plane is received through the input/output pad, and the nonvolatile memory device may store the data DATA_W2 in the cache latches LT_C of the sub-page buffer circuit corresponding to the second target plane. This data output operation for the second target plane may be performed between the ‘E’ time point and the ‘F’ time point.

As a result, as illustrated in FIG. 10A, in order to perform the data input operation for the first target plane and the second target plane, it may take ‘2*T1’ time to receive the command and the address.

Referring to FIG. 8 and FIG. 10B, under a situation that supports a multi-plane address according to an embodiment of the present disclosure, the data input operation for the first target plane and the second target plane may be performed.

Specifically, a command set CMD SET according to an embodiment of the present disclosure may be received through an input/output pad 117. The command set CMD SET may include a data input command CMD_Din and a multi-plane address MADDR. For example, the data input commands CMD_Din may be “80h”. It may take a fourth time T4 to receive the command set CMD SET, and the fourth time T4 may be the same as or similar to the third time T3.

The multi-plane address MADDR may include row addresses for two target planes. In addition, the multi-plane address MADDR may include column addresses for two target planes.

Thereafter, data DATA_W1 for the first target plane and data DATA_W2 for the second target plane may be sequentially received through the input/output pad 117. The nonvolatile memory device 110A may store data DATA_W1 in cache latches LT_C of the sub-page buffer circuit corresponding to the first target plane and store data DATA_W2 in cache latches LT_C of the sub-page buffer circuit corresponding to the second target plane.

As a result, when compared with FIG. 10A, the time required to receive a command set required for a data input operation according to the embodiment of the present disclosure illustrated in FIG. 10B may be reduced compared to FIG. 10A. In this way, by reducing the command-address overhead, the data input performance may be improved.

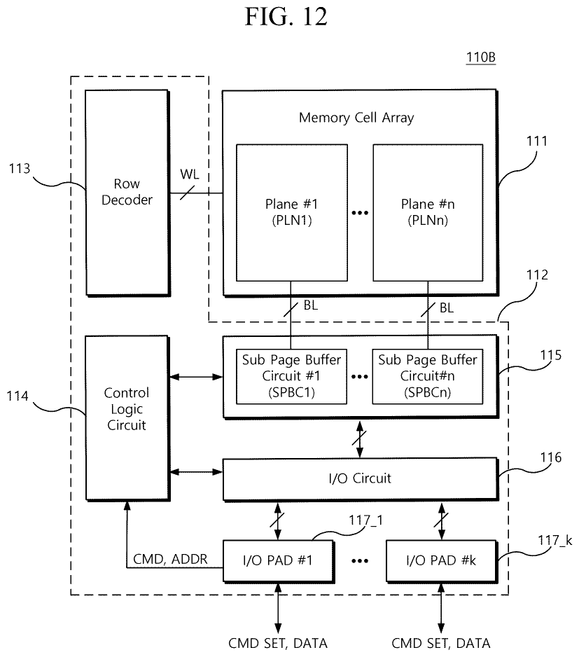

FIG. 11 is a block diagram showing a storage system according to an embodiment of the present disclosure. FIG. 12 illustrates an example of a nonvolatile memory device of FIG. 11 in more detail. The storage system 100B of FIG. 11 is similar to each of the storage systems 100 and 100A of FIG. 1 and FIG. 3. In addition, the nonvolatile memory device 110B of FIG. 12 is similar to the nonvolatile memory device 110A of FIG. 5 to FIG. 7. Therefore, the same or similar components are indicated by the same or similar reference numerals, and redundant descriptions will be omitted. Referring to FIG. 11 and FIG. 12, the storage system 100B may include a nonvolatile memory device 110B and a memory controller 120B.

The nonvolatile memory device 110B may include a plurality of input/output pads 117_1 to 117_k. The nonvolatile memory device 110B may receive or transmit a command set CMD SET and/or data DATA through the plurality of input/output pads 117_1 to 117_k.

For example, the nonvolatile memory device 110B may receive a command set CMD SET for a data output operation from a memory controller 120B through at least one of the plurality of input/output pads 117_1 to 117_k. In this case, the multi-plane address MADDR of the command set CMD SET may further include a pad address for selecting an input/output pad from among the plurality of input/output pads 117_1 to 117_k to which data of the target plane will be output. The nonvolatile memory device 110B may transmit data DATA of the target plane to the memory controller 120B through the input/output pad selected from among the plurality of input/output pads 117_1 to 117_k.

In one embodiment, when a data output operation is performed for at least two target planes among the plurality of planes PLN1 to PLNn, the output data of each of the at least two target planes may be output through different input/output pads. In this case, the output data of each of the at least two target planes may be output in parallel.

For example, similarly to FIGS. 1 to 5 and 8, the nonvolatile memory device 110B can select a first sub-page buffer circuit corresponding to a first target plane and a second sub-page buffer circuit corresponding to a second target plane by decoding a column address for a target plane included in the multi-plane address MADDR. In addition, the nonvolatile memory device 110B can select a first input/output pad corresponding to the first target plane and a second input/output pad corresponding to the second target plane by decoding a pad address included in the multi-plane address MADDR. In this case, data stored in the first sub-page buffer circuit corresponding to the first target plane can be output through the first input/output pad, and data stored in the second sub-page buffer circuit corresponding to the second target plane can be output through the second input/output pad.

In another embodiment, when the data output operation is performed for at least two target planes among the plurality of planes PLN1 to PLNn, the output data of each of the at least two target planes may be output through the same input/output pad. In this case, the output data of each of the at least two target planes may be output sequentially.

For example, similarly to FIGS. 1 to 5 and 8, the nonvolatile memory device 110B can select a first sub-page buffer circuit corresponding to a first target plane and a second sub-page buffer circuit corresponding to a second target plane by decoding column addresses for the target planes included in the multi-plane address MADDR. In addition, the nonvolatile memory device 110B can select the first input/output pad as both the input/output pads corresponding to the first and the second target planes by decoding a pad address included in the multi-plane address MADDR. In this case, data stored in the first sub-page buffer circuit corresponding to the first target plane can be first outputted through the first input/output pad, and then data stored in the second sub-page buffer circuit corresponding to the second target plane can be outputted through the first input/output pad.

In one embodiment, the nonvolatile memory device 110B may include a switch circuit for connecting one of the input/output pads 117_1 to 117_k to one of the sub-page buffer circuits SPBC1 to SPBCn. For example, the input/output circuit 116 may include the switch circuit. The switch circuit may include at least one switch. The switch may be implemented to include, for example, a switching transistor. For example, when the first sub-page buffer circuit SPBC1 is selected among the plurality of sub-page buffer circuits SPBC1 to SPBCn and the first input/output pad 117_1 is selected among the input/output pads 117_1 to 117_k, the switch arranged between the first sub-page buffer circuit SPBC1 and the first input/output pad 117_1 may be turned on, and the remaining switches may be turned off.

In this way, the nonvolatile memory device 110B according to an embodiment of the present disclosure may include the plurality of input/output pads 117_1 to 117_k, and the command set CMD SET may further include the pad address for selecting the input/output pad among the plurality of input/output pads 117_1 to 117_k on which the data input/output operation is to be performed.

Accordingly, data stored in at least two planes may be output in parallel through different input/output pads, or may be output sequentially through the same input/output pad. Accordingly, the flexibility of the data input/output operation according to embodiments of the present disclosure may be increased. In addition, the data input/output operation according to embodiments of the present disclosure may reduce the command-address overhead. As a result, the data input/output performance may be further improved.

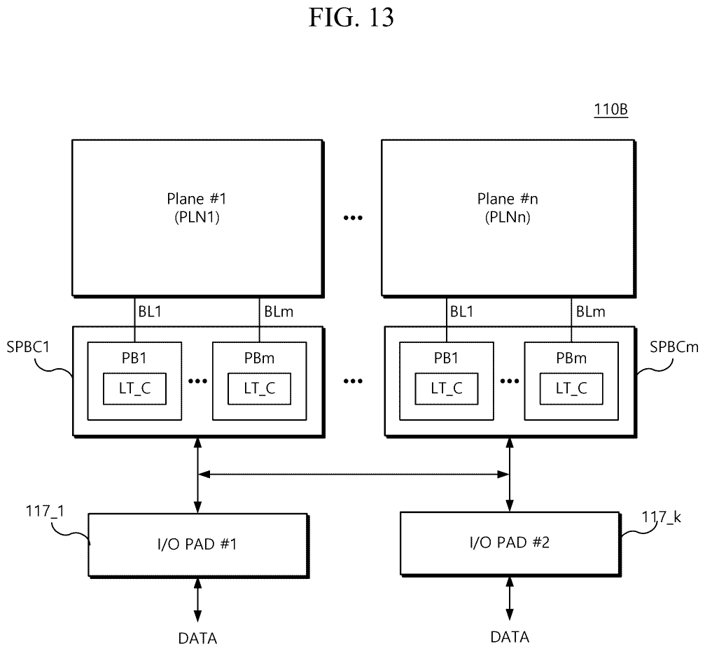

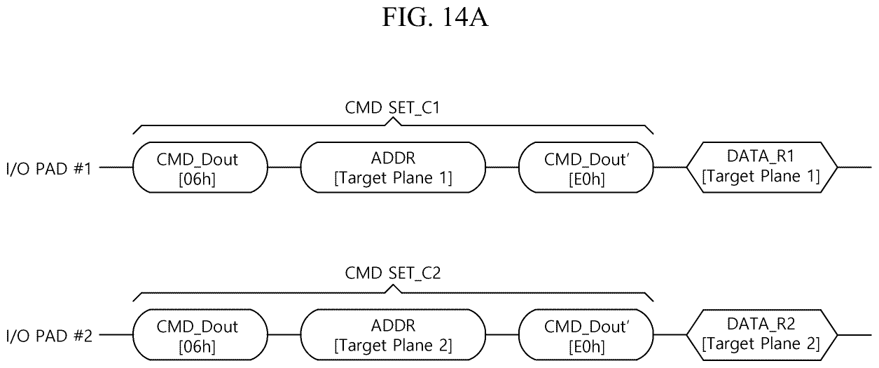

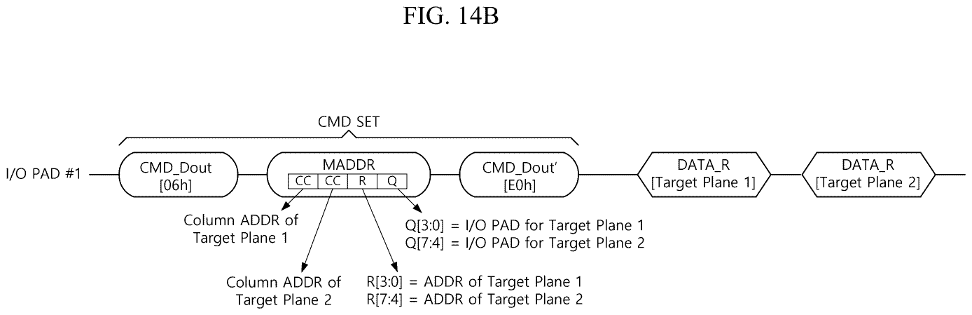

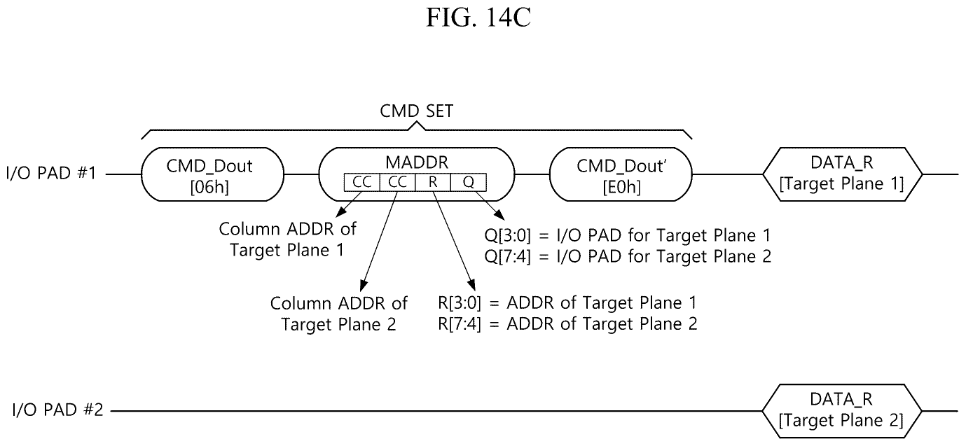

FIG. 13 to FIG. 14C are drawings for explaining an example of a data output operation of a nonvolatile memory device according to an embodiment of the present disclosure.

Specifically, in FIG. 13, a correspondence relationship between a plurality of input/output pads and a plurality of sub-page buffer circuits is exemplarily illustrated. In FIG. 14A, a comparative example of a data output sequence in a case where a multi-plane address is not supported is illustrated. In FIG. 14B, a data output sequence according to an embodiment of the present disclosure that outputs data through the same input/output pad is illustrated. In FIG. 14C, a data output sequence according to an embodiment of the present disclosure that outputs data through different input/output pads is illustrated.

The data output operations of FIG. 13 to FIG. 14C are similar to the data input/output operations of FIG. 8 to FIG. 10B. Therefore, the same or similar configurations are indicated by the same or similar reference numerals, and redundant descriptions will be omitted. For convenience of explanation, the data input/output operation in a DMA operation will be mainly described below. In this case, the DMA operation is performed in plane units, and therefore, only the address of the target plane will be provided as a row address.

Referring to FIG. 13, the nonvolatile memory device 110B may include a plurality of planes PLN1 to PLNn, a plurality of sub-page buffer circuits SPBC1 to SPBCn, and a plurality of input/output pads 117_1 to 117_k.

Each of the plurality of input/output pads 117_1 to 117_k may be selectively connected to one of the plurality of sub-page buffer circuits SPBC1 to SPBCn.

For example, during a data output operation for the first plane PLN1, a selected input/output pad among the plurality of input/output pads 117_1 to 117_k may be connected to the first sub-page buffer circuit SPBC1. Accordingly, data DATA stored in the cache latches LT_C of the first sub-page buffer circuit SPBC1 may be transmitted to the outside through the selected input/output pad. In addition, during a data input operation for the first plane PLN1, a selected input/output pad among the plurality of input/output pads 117_1 to 117_k may be connected to the first sub-page buffer circuit SPBC1. Accordingly, data DATA received from the outside may be stored in the cache latches LT_C of the first sub-page buffer circuit SPBC1 through the selected input/output pad.

Similarly, during a data input/output operation for the nth plane PLNn, a selected input/output pad among the plurality of input/output pads 117_1 to 117_k may be connected to the nth sub-page buffer circuit SPBCn.

As described in FIG. 12, the nonvolatile memory device 110B may include a switch circuit for selecting any one of the input/output pads 117_1 to 117_k.

Referring to FIG. 13 and FIG. 14A, a data output operation for the first target plane and the second target plane may be performed in a situation where the multi-plane address is not supported.

A first command set CMD SET_C1 may be received through a first input/output pad. The first command set CMD SET_C1 may include a data output command CMD_Dout, an address ADDR, and a data output command CMD_Dout′. The address ADDR may include a row address for a first target plane. The nonvolatile memory device may output data DATA_R1 stored in cache latches LT_C of a sub-page buffer circuit corresponding to the first target plane through the first input/output pad.

In addition, a second command set CMD SET_C2 may be received through the second input/output pad. The second command set CMD SET_C2 may include a data output command CMD_Dout, an address ADDR, and a data output command CMD_Dout′. The address ADDR may include a row address for the second target plane. The nonvolatile memory device may output data DATA_R2 stored in cache latches LT_C of a sub-page buffer circuit corresponding to the second target plane through the second input/output pad.

In this way, when a multi-plane address is not supported, data corresponding to a command set received through a specific input/output pad is output through the same input/output pad. This means less flexibility in utilizing multiple input/output pads. Therefore, the flexibility of utilization for multiple input/output pads needs to be improved.

Referring to FIG. 13, FIG. 14B and FIG. 14C, in a situation where a multi-plane address is supported according to an embodiment of the present disclosure, a data output operation for the first target plane and the second target plane may be performed.

Specifically, a command set CMD SET according to an embodiment of the present disclosure may be received through an input/output pad 117. The command set CMD SET may include a data output command CMD_Dout, a multi-plane address MADDR and a data output command CMD_Dout′.

The multi-plane address MADDR may include row addresses for two target planes. For example, the row address ‘R’ has a bit width of 1-byte, ‘R[3:0]’ may correspond to the address of the first target plane, and ‘R[7:4]’ may correspond to the address of the second target plane.

In addition, the multi-plane address MADDR may include column addresses for two target planes. For example, the column address ‘C’ has a bit width of 1-byte, and among the 4-byte column addresses ‘CCCC’, the first ‘CC’ may correspond to the column address for the first target plane, and the second ‘CC’ may correspond to the column address for the second target plane.

In addition, the multi-plane address MADDR may include pad addresses for two target planes. For example, pad address ‘Q’ has a bit width of 1-byte, ‘Q[3:0]’ may correspond to the address of the input/output pad corresponding to the first target plane, and ‘Q[7:4]’ may correspond to the address of the input/output pad corresponding to the second target plane.

In one embodiment, as illustrated in FIG. 14B, both the address of the input/output pad for the first target plane and the address of the input/output pad for the second target plane may correspond to the first input/output pad. In this case, data DATA_R1 stored in the cache latches LT_C of the sub-page buffer circuit corresponding to the first target plane and data DATA_R2 stored in the cache latches LT_C of the sub-page buffer circuit corresponding to the second target plane may be sequentially output through the first input/output pad.

For example, the nonvolatile memory device 110B can select a first sub-page buffer circuit corresponding to a first target plane and a second sub-page buffer circuit corresponding to a second target plane by decoding column addresses for target planes included in a multi-plane address MADDR. In addition, the nonvolatile memory device 110B can select the first input/output pad as both the input/output pads corresponding to the first and second target planes by decoding a pad address included in the multi-plane address MADDR. In this case, data stored in the first sub-page buffer circuit corresponding to the first target plane can be first output through the first input/output pad, and then data stored in the second sub-page buffer circuit corresponding to the second target plane can be output through the first input/output pad.

In another embodiment, as illustrated in FIG. 14C, the address of an input/output pad for the first target plane may correspond to the first input/output pad, and the address of the input/output pad for the second target plane may correspond to the second input/output pad. In this case, data DATA_R1 stored in cache latches LT_C of the sub-page buffer circuit corresponding to the first target plane may be output through the first input/output pad, and data DATA_R2 stored in cache latches LT_C of the sub-page buffer circuit corresponding to the second target plane may be output through the second input/output pad. Therefore, data DATA_R1 and data DATA_R2 may be output in parallel through different input/output pads.

For example, the nonvolatile memory device 110B can select a first sub-page buffer circuit corresponding to a first target plane and a second sub-page buffer circuit corresponding to a second target plane by decoding column addresses for target planes included in a multi-plane address MADDR. In addition, the nonvolatile memory device 110B can select a first input/output pad corresponding to the first target plane and a second input/output pad corresponding to the second target plane by decoding a pad address included in the multi-plane address MADDR. In this case, data stored in the first sub-page buffer circuit corresponding to the first target plane can be output through the first input/output pad, and data stored in the second sub-page buffer circuit corresponding to the second target plane can be output through the second input/output pad in parallel.

In conclusion, compared to FIG. 14A, in the data output operation according to the embodiment of the present disclosure illustrated in FIG. 14B and FIG. 14C, the input/output pads may be selected, and thus the flexibility of the data input/output operation can be increased. In addition, the data input/output operation according to embodiments of the present disclosure may reduce command-address overhead. As a result, the data input/output performance may be further improved.

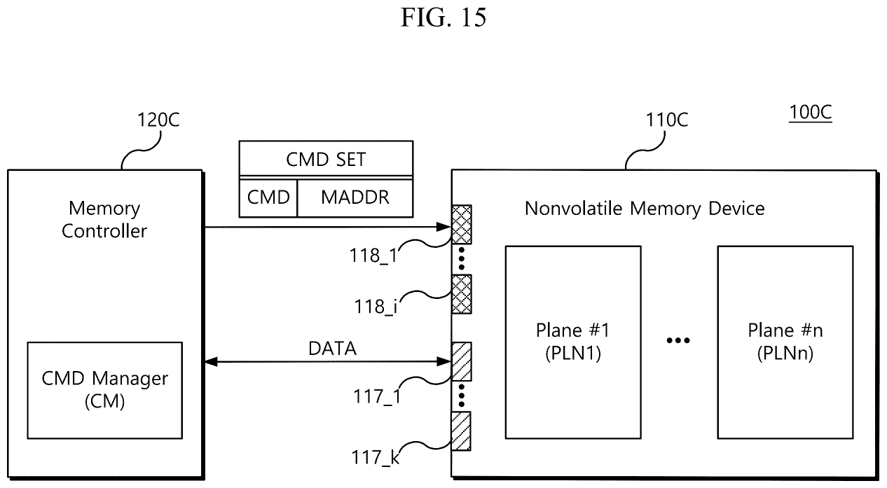

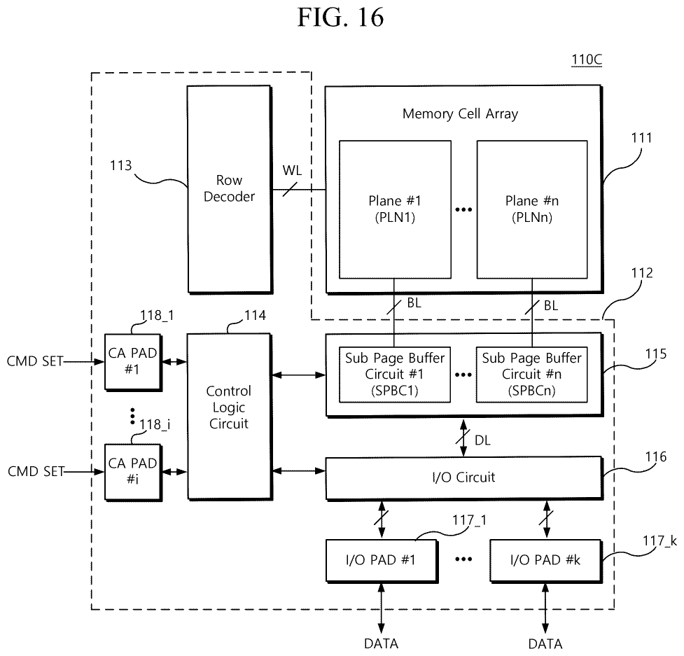

FIG. 15 is a block diagram showing a storage system according to an embodiment of the present disclosure. FIG. 16 is a block diagram showing an example of a nonvolatile memory device of FIG. 15 in more detail. The storage system 100C of FIG. 15 is similar to the storage systems 100, 100A and 100B of FIG. 1, FIG. 3, and FIG. 11. In addition, the nonvolatile memory device 110C of FIG. 16 is similar to the nonvolatile memory devices 110A and 110B of FIG. 5 to FIG. 7 and FIG. 12. Therefore, the same or similar configurations are indicated by the same or similar reference numerals, and redundant descriptions will be omitted. Referring to FIG. 15 and FIG. 16, the storage system 100C may include the nonvolatile memory device 110C and a memory controller 120C.

The nonvolatile memory device 110C may include at least one command address pad (hereinafter, “CA pad”, 118_1 to 118_i). The nonvolatile memory device 110C may receive or transmit a command set CMD SET through at least one CA pad 118_1 to 118_i.

For example, the nonvolatile memory device 110C may receive the command set CMD SET for a data output operation from the memory controller 120B through at least one CA pad 118_1 to 118_i. Each of the at least one CA pad 118_1 to 118_i may transmit the received command set CMD SET to the control logic circuit 114. In this case, the multi-plane address MADDR of the command set CMD SET may include a pad address that selects an input/output pad from among the plurality of input/output pads 117_1 to 117_k to which data of the target plane is to be output.

The nonvolatile memory device 110C may include the plurality of input/output pads 117_1 to 117_k. The nonvolatile memory device 110C may receive or transmit data DATA through the plurality of input/output pads 117_1 to 117_k.

For example, the nonvolatile memory device 110C may transmit data DATA of the target plane to a memory controller 120C through at least one input/output pad selected from among the plurality of input/output pads 117_1 to 117_k.

In this way, the nonvolatile memory device 110C according to embodiments of the present disclosure may include at least one CA pad 118_1 to 118_i and the plurality of input/output pads 117_1 to 117_k. In this case, the command set CMD SET may be received through at least one CA pad 118_1 to 118_i, and the data DATA may be received or transmitted through a selected input/output pad among the plurality of input/output pads 117_1 to 117_k.

By separating the transmission paths of the command set CMD SET and the data DATA, the data input/output operation according to the embodiment of the present disclosure may reduce the command-address overhead. As a result, the data input/output performance may be further improved.

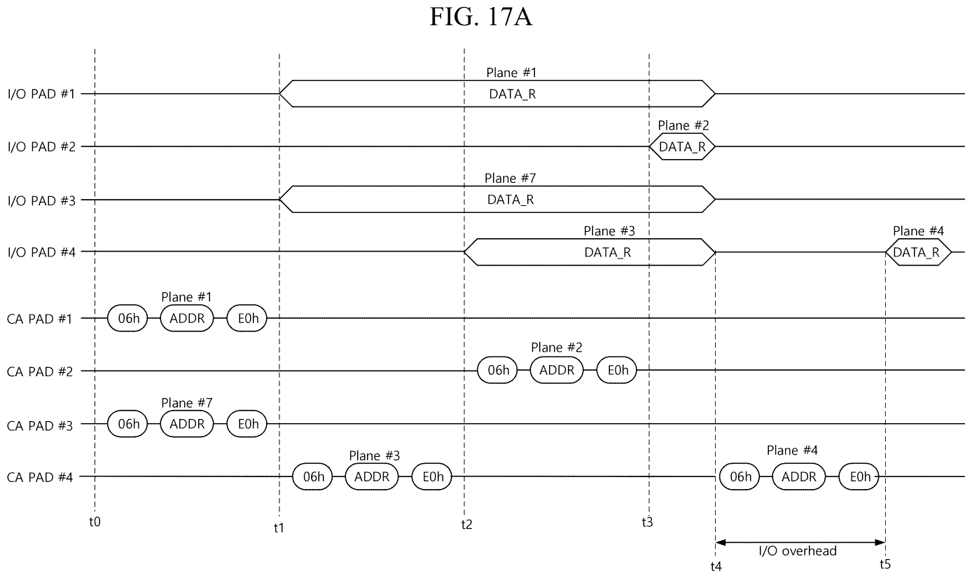

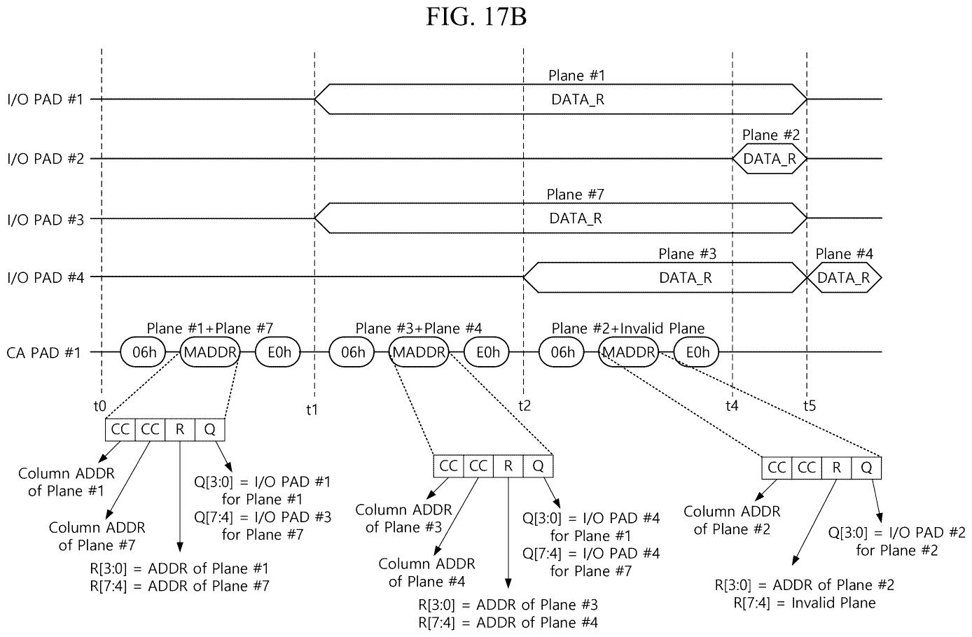

FIG. 17A and FIG. 17B are drawings for explaining an example of a data output operation of a nonvolatile memory device according to an embodiment of the present disclosure.

Specifically, FIG. 17A illustrates a comparative example of receiving a command set through multiple CA command pads in a case where a multi-plane address is not supported. In FIG. 17B, an embodiment of the present disclosure is illustrated for receiving a command set through one CA pad.

The data output operations of FIG. 17A and FIG. 17B are similar to the data output operations of FIG. 13 to FIG. 14C. Therefore, identical or similar configurations are indicated by identical or similar reference numerals, and redundant descriptions will be omitted.

For convenience of explanation, in FIG. 17A and FIG. 17B, it is assumed that the first input/output pad outputs data stored in the first plane at the time point ‘t1’, the second input/output pad outputs data stored in the second plane at the time point ‘t3’, the third input/output pad outputs data stored in the seventh plane at the time point ‘t1’, and the fourth input/output pad outputs data stored in the third and fourth planes at the time points ‘t2’ and ‘t5’. In addition, in FIG. 17B, it is assumed that the first input/output pad outputs data stored in the first plane at the time point ‘t1’, the second input/output pad outputs data stored in the second plane at the time point ‘t4’, the third input/output pad outputs data stored in the seventh plane at the time point ‘t1’, and the fourth input/output pad outputs data stored in the third and fourth planes at the time points ‘t2’ and ‘t5’.

Referring to FIG. 17A, data output operations for the selected first, second, third, fourth, and seventh planes may be performed in a situation where the multi-plane address is not supported.

First, during the time between the time points ‘t0’ and ‘t1’, a command set requesting data output for the 1st plane may be received via the 1st CA pad, and a command set requesting data output for the 7th plane may be received via the 3rd CA pad.

Afterwards, during the time between the time points ‘t1’ and ‘t2’, a command set requesting data output for the 3rd plane may be received via the 4th CA pad.

Afterwards, during the time between the time points ‘t2’ and ‘t3’, a command set requesting data output for the 2nd plane may be received via the 2nd CA pad.

Afterwards, during the time between the time points ‘t4’ and ‘t5’, a command set requesting data output for the 4th plane may be received via the 4th CA pad.

In this way, in a situation where the multi-plane address is not supported, there is an overhead issue that four CA pads are required to perform data output operations for the selected 1st, 2nd, 3rd, 4th and 7th planes.

In addition, while data is being output through the input/output pad, the command set corresponding to the input/output pad may not be received. Since the data output operation for the third plane through the fourth input/output pad and the data output operation for the fourth plane are not performed immediately sequentially, there is an input/output overhead corresponding to the time between the fourth and fifth time points ‘t4’ to ‘t5’.

Referring to FIG. 17B, in a situation where the multi-plane address according to an embodiment of the present disclosure is supported, data output operations for the selected first, second, third, fourth, and seventh planes may be performed.

First, during the time between the time points ‘t0’ and ‘t1’, a command set requesting data output for the 1st plane and the 7th plane may be received through the 1st CA pad. In this case, the row address may correspond to the 1st plane and the 7th plane. In addition, the pad address corresponding to the 3rd plane may be the 1st input/output pad, and the pad address corresponding to the 7th plane may be the 3rd input/output pad.

Afterwards, during the time between the time points ‘t1’ and ‘t2’, the command set requesting data output for the 3rd plane and the 4th plane may be received through the 1st CA pad. In this case, the row address may correspond to the 3rd plane and the 4th plane. In addition, the pad address may correspond to the 4th input/output pad. In addition, the pad addresses corresponding to the 3rd and 4th planes may both be the 4th input/output pad.

During the time between the time points ‘t2’ and ‘t4’, a command set requesting data output for the second plane may be received through the first CA pad. In this case, the row address may correspond to the second plane and the invalid plane (e.g., unselected plane). In addition, the pad address corresponding to the second plane may be the second input/output pad.

Here, the fact that the row address corresponds to the address of the invalid plane may mean that the plane where the data is output is not selected. In other words, in order to maintain the format of the command set that includes addresses for two target planes, ‘R[3:0]’ may correspond to the address of the second plane, and ‘R[7:4]’ may correspond to the address of the invalid plane.

In conclusion, compared to FIG. 17A, the data output operation according to the embodiment of the present disclosure illustrated in FIG. 17B may use only one CA pad to perform the data output operation for the selected first, second, third, fourth and seventh planes. In addition, the continuous data output operation may be performed without the input/output overhead as in FIG. 17A. Additionally, the data input/output operation according to this embodiment of the present disclosure may reduce the command-address overhead. As a result, the data input/output performance may be further improved.

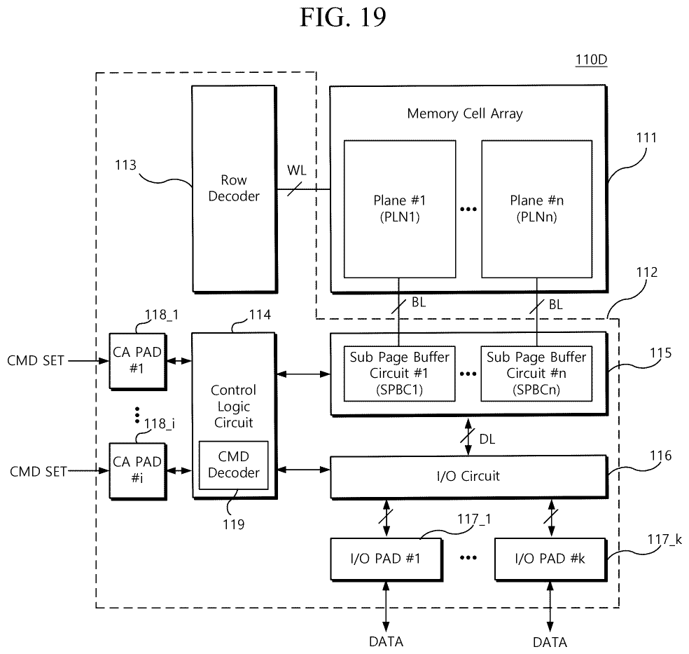

FIG. 18 is a block diagram showing a storage system according to an embodiment of the present disclosure. FIG. 19 is a block diagram showing an example of a nonvolatile memory device of FIG. 18 in more detail. The storage system 100D of FIG. 18 is similar to the storage systems 100, 100A, 100B and 100C of FIGS. 1, 3, 11, and 15. In addition, the nonvolatile memory device 110D of FIG. 19 is similar to the nonvolatile memory devices 110A, 110B and 110C of FIGS. 5 to 7, 12, and 16. Accordingly, identical or similar configurations are indicated by identical or similar reference numerals, and redundant descriptions will be omitted. Referring to FIG. 18 and FIG. 19, the storage system 100D may include a nonvolatile memory device 110D and a memory controller 120d.

The memory controller 120D includes a command manager CM, and the command manager CM may include a command encoder 128. The command encoder 128 may encode a command and row addresses for at least two target planes corresponding to the command, thereby generating an encoded command CMD_E. In other words, the encoded command CMD_E may include the command and row addresses for at least two target planes corresponding to the command. Accordingly, a command set CMD SET generated by the command manager CM may include the encoded command CMD_E and the multi-plane address MADDR.

The nonvolatile memory device 110D may further include a command decoder 119. For example, a control logic circuit 114 of the nonvolatile memory device 110D may be implemented to include the command decoder 119.

For example, the command decoder 119 may receive the command set CMD SET through at least one of the plurality of CA pads 118_1 to 118_i. The command decoder 119 may perform a decoding operation for the encoded command CMD_E in the command set CMD SET. Accordingly, the row address for the command and at least two target planes corresponding thereto may be identified.

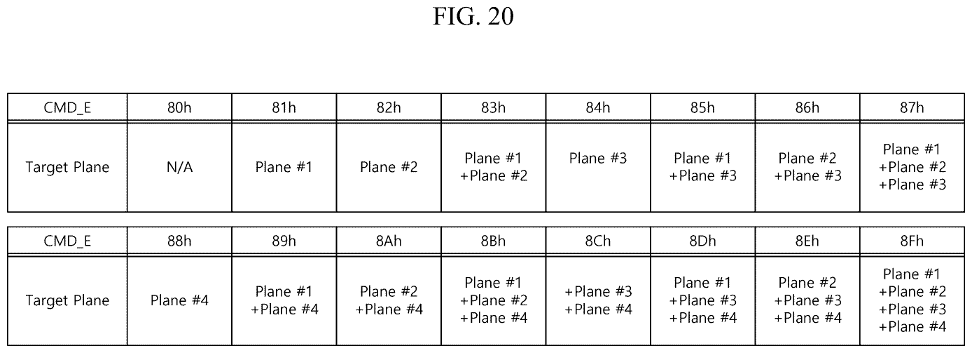

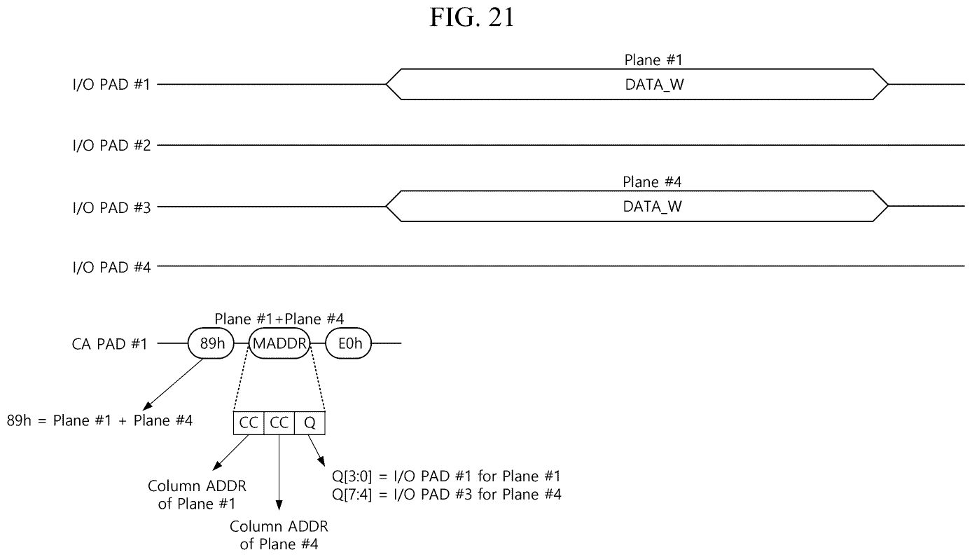

FIG. 20 and FIG. 21 are drawings for explaining an example of a data output operation of a nonvolatile memory device according to an embodiment of the present disclosure. Specifically, FIG. 20 illustrates an example of an encoded command CMD_E. FIG. 21 illustrates an embodiment of the present disclosure for receiving a command set CMD SET including an encoded command CMD_E and a multi-plane address MAPP.

Referring to FIG. 20, for example, the encoded command CMD_E may be a data input command. In this case, the encoded command CMD_E may be “8Xh”. For example, if the output requested target plane is the first plane, the encoded data input command CMD_E may be “81h”. For example, if the target plane is the second plane, the encoded data input command CMD_E may be “82h”. For example, if the target planes are the first and second planes, the encoded data input command CMD_E may be “83h”. In this way, based on at least one target plane for which data input is requested, the data input command may be encoded in different forms. As a result, based on the data input command used, data received by a selected input/output pad can be input to the selected one or more planes.

In FIG. 20, the encoded command CMD_E is described as the data input command. However, this description is exemplary, and the present invention is not limited thereto. According to an embodiment, the encoded command CMD_E may be a data output command. In this case, the encoded data output command CMD_E may be “X6h”.

Referring to FIG. 21, “89h” may be received as the encoded command CMD_E through the first CA pad. In this case, it may be confirmed through a decoding operation that the encoded command CMD_E is a data input command, and that the first and fourth planes are target planes.

In addition, a multi-plane address MADDR may be received. In this case, the pad address corresponding to the first plane may be the first input/output pad, and the pad address corresponding to the fourth plane may be the third input/output pad.

Accordingly, as illustrated in FIG. 21, data stored in the first plane may be transmitted to cache latches of the corresponding sub-page buffer circuit through the first input/output pad. In addition, data stored in the fourth plane may be transmitted to cache latches of the corresponding sub-page buffer circuit through the third input/output pad.

Ultimately, the data input/output operation according to embodiments of the present disclosure may reduce command-address overhead. As a result, data input/output performance may be improved.

The above are specific embodiments for carrying out the present invention. In addition to the above-described embodiments, the present invention may include simple design changes or easily changeable embodiments. In addition, the present invention will include techniques that may be easily modified and implemented using the embodiments. Therefore, the scope of the present invention should not be limited to the above-described embodiments, and should be defined by the claims and equivalents of the claims as well as the claims to be described later.

What is claimed is:

1. A nonvolatile memory device, comprising:
a memory cell array including a plurality of planes; and
a control logic circuit configured to control a data output operation or a data input operation for the plurality of planes in response to a command set,
wherein the command set includes addresses for at least two target planes among the plurality of planes.

2. The nonvolatile memory device of claim 1, further comprising:
a page buffer circuit including a plurality of sub-page buffer circuits corresponding to the plurality of planes; and
an input/output pad configured to receive the command set and selectively connected to the plurality of sub-page buffer circuits,
wherein in response to receiving the command set, first data stored in a first target plane among the plurality of planes and second data stored in a second target plane among the plurality of planes are sequentially output through the input/output pad.

3. The nonvolatile memory device of claim 1, further comprising:
a page buffer circuit including a plurality of sub-page buffer circuits corresponding to the plurality of planes;
a first input/output pad selectively connected to the plurality of sub-page buffer circuits; and
a second input/output pad selectively connected to the plurality of sub-page buffer circuits,
wherein the command set comprises:
a first pad address designating an input/output pad from among the first input/output pad and the second input/output pad to which data stored in a first target plane is to be output; and
a second pad address designating an input/output pad from among the first input/output pad and the second input/output pad to which data stored in a second target plane is to be output.

4. The nonvolatile memory device of claim 3, wherein when the first pad address and the second pad address are different from each other, the data stored in the first target plane and the data stored in the second target plane are output in parallel through the first input/output pad and the second input/output pad.

5. The nonvolatile memory device of claim 3, wherein when the first pad address and the second pad address are the same, the data stored in the first target plane and the data stored in the second target plane are sequentially output through one of the first input/output pad and the second input/output pad.

6. The nonvolatile memory device of claim 3, further comprising:
a command address pad configured to receive the command set.

7. The nonvolatile memory device of claim 3, wherein the command set includes:
a first row address for the first target plane;
a second row address for the second target plane;
a first column address for the first target plane; and
a second column address for the second target plane.

8. The nonvolatile memory device of claim 1, wherein the command set includes an encoded command,
wherein the encoded command includes one of a data output command or a data input command, and row addresses for the at least two target planes.

9. The nonvolatile memory device of claim 1, wherein the command set includes an address for an unselected plane among the plurality of planes.

10. A memory controller, comprising:
a nonvolatile memory interface configured to communicate with a nonvolatile memory device; and
a command manager configured to generate a command set to be transmitted to the nonvolatile memory device through the nonvolatile memory interface,
wherein the command set includes addresses for at least two target planes among a plurality of planes included in the nonvolatile memory device.

11. The memory controller of claim 10, wherein the command set includes:
a first row address for a first target plane among the plurality of planes;
a second row address for a second target plane among the plurality of planes;
a first column address for the first target plane; and
a second column address for the second target plane.

12. The memory controller of claim 10, wherein the command set includes an encoded command,
wherein the encoded command includes one of a data output command or a data input command, and row addresses for the at least two target planes.

13. The memory controller of claim 10, wherein the command set includes an address for an unselected plane among the plurality of planes.

14. The memory controller of claim 10, wherein the command set includes:
a first pad address designating an input/output pad to which data stored in a first target plane among the plurality of planes is to be output; and
a second pad address designating an input/output pad to which data stored in a second target plane among the plurality of planes is to be output.

15. A storage system, comprising:
a first device configured to store data; and
a second device configured to receive data from the first device or provide data to the first device,
wherein the first device comprises a plurality of planes having memory cells storing data,
wherein the second device is configured to generate a command set requesting data input or output for the plurality of planes,
wherein the command set includes addresses of at least two target planes among the plurality of planes.

16. The storage system of claim 15, wherein the first device comprises:
a memory cell array comprising the plurality of planes;
a control logic circuit configured to control a data output operation or a data input operation for the plurality of planes in response to a command set;
a page buffer circuit including a plurality of sub-page buffer circuits corresponding to the plurality of planes; and
an input/output pad configured to receive the command set and selectively connected to the plurality of sub-page buffer circuits,
wherein first data stored in a first target plane among the plurality of planes and second data stored in a second target plane among the plurality of planes are sequentially output through the input/output pad.

17. The storage system of claim 15, wherein the first device further comprises:
a memory cell array including the plurality of planes;
a control logic circuit configured to control a data output operation or a data input operation for the plurality of planes in response to a command set;
a page buffer circuit including a plurality of sub-page buffer circuits corresponding to the plurality of planes;
a first input/output pad selectively connected to the plurality of sub-page buffer circuits; and
a second input/output pad selectively connected to the plurality of sub-page buffer circuits,
wherein the command set comprises:
a first pad address designating an input/output pad from among the first input/output pad and the second input/output pad to which data stored in a first target plane is to be output; and
a second pad address designating an input/output pad from among the first input/output pad and the second input/output pad to which data stored in a second target plane is to be output.

18. The storage system of claim 17, wherein when the first pad address and the second pad address are different from each other, the data stored in the first target plane and the data stored in the second target plane are output in parallel through the first input/output pad and the second input/output pad.

19. The storage system of claim 17, wherein when the first pad address and the second pad address are the same, the data stored in the first target plane and the data stored in the second target plane are sequentially output through one of the first input/output pad and the second input/output pad.

20. The storage system of claim 15, wherein the command set further includes an encoded command,
wherein the encoded command includes one of a data output command or a data input command, and a row address for the at least two target planes.
